(19) United States
(12) Patent Application Publication
(10) Pub. No.: US 2014/0178735 A1
(43) Pub. Date: Jun. 26, 2014

(54) REDOX FLOW BATTERY SYSTEM

(71) Applicants: Qing Wang, Singapore (SG); Qizhao Huang, Singapore (SG)

(72) Inventors: Qing Wang, Singapore (SG); Qizhao Huang, Singapore (SG)

(73) Assignee: National University of Singapore, Singapore (SG)

(21) Appl. No.: 14/232,968

(22) PCT Filed: Jul. 5, 2012
(86) PCT No.: PCT/SG2012/000239

§ 371 Date: Jan. 15, 2014

Related U.S. Application Data
(60) Provisional application No. 61/510,132, filed on Jul. 21, 2011.

(51) Int. Cl. H01M 8/18; H01M 8/20

(52) U.S. Cl. CPC H01M 8/188; H01M 8/20
USPC 429/105

(57) ABSTRACT

A redox flow battery system having an electrochemical cell and an energy reservoir. The system includes a cathodic compartment, an anodic compartment, a separator that divides the two compartments, and an energy reservoir which contains an electro-active material, electro-active ions, an electrolyte, and a redox mediator. The reservoir is connected to either the cathodic compartment or the anodic compartment via an inlet-outlet pair for circulating the electrolyte from the energy reservoir to the cathodic compartment or the anodic compartment.

### BACKGROUND

High energy density batteries are desired for applications in consumer electronics and for storage of renewable energy.

Lithium ion battery is one of the state-of-the-art power sources. During charging of a lithium ion battery, lithium ions move from the cathodic electrode to the anodic electrode through a separator, and conversely during discharging. Current lithium ion batteries are not suitable for large-scale energy storage over safety concerns even though their energy densities are as high as 250 Wh/kg. In addition, these batteries require a long charging time. Their use is thus limited to applications that do not require instant recharging or refueling.

Differently, redox flow batteries are energy storage devices that supply electricity converted from chemical energy, which is stored in active electrode species dissolved in electrolyte. During the operation of the batteries, the active species are oxidized or reduced. These batteries in general suffer from a low energy density, e.g., 25 Wh/kg.

There is a need to develop a safe battery system that has a high energy density and can be refueled instantly.

### SUMMARY

This disclosure is based on the unexpected discovery of a safe redox flow battery system that has a high energy density and can be refueled instantly.

Accordingly, the redox flow battery system contains an energy reservoir and one or more electrochemical cells, each of which includes a cathodic compartment, an anodic compartment, and a separator. The cathodic compartment has a cathodic electrode connected to one or more other cells or to an external load. The anodic compartment has an anodic electrode also connected to one or more other cells or to an external load. These two compartments are divided by the separator. The energy reservoir contains an electro-active material that stores electro-active ions, an electrolyte that contains the electro-active ions, and a redox mediator in the electrolyte. The reservoir is connected to either the cathodic compartment or the anodic compartment via an outlet for delivering the electrolyte from the energy reservoir to the cathodic compartment or the anodic compartment, and also via an inlet for returning the electrolyte from the cathodic compartment or the anodic compartment to the reservoir.

The separator divides the cathodic compartment and the anodic compartment. It can be an electro-active ion conducting membrane (e.g., a lithium ion conducting membrane). For example, the separator is a lithium phosphorus oxynitride glass, a lithium thiophosphate glass, a NASICON-type lithium conducting glass ceramic, a Garnet-type lithium conducting glass ceramic, a ceramic nanofiltration membrane, a lithium ion-exchange membrane, or a combination thereof.

Both electrodes in the battery system, i.e., the cathodic electrode and the anodic electrode, can be a carbon, a metal, or a combination thereof.

The electrolyte can be a solution in which one or more electro-active ion compounds (e.g., lithium salts) are dissolved in a polar protic solvent, an aprotic solvent, or a combination thereof. For example, the electrolyte can be a solution in which LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAlO₄, LiAlCl₄, LiCl, LiI, lithium bis(oxalato)borate (i.e., LiBOB), or a combination thereof is dissolved in water, a carbonate, an ether, an ester, a ketone, a nitrile, or a combination thereof. The concentration of the lithium salt in the electrolyte can be 0.1 to 5 mol/L (e.g., 0.5 to 1.5 mol/L).

Optionally, the battery system contains two energy reservoirs, i.e., a cathodic reservoir connected to the cathodic compartment and an anodic reservoir connected to the anodic compartment.

The cathodic reservoir can contain an electrolyte, a cathodic electro-active material and a p-type redox mediator. The cathodic electro-active material can be a metal fluoride, a metal oxide, Li_{1-x-z}M_{1-z}PO₄, (Li_{1-y}Z_{y})MPO₄, LiMO₂, LiM₂O₄, Li₂MSiO₄, LiMPO₄F, LiMSO₄F, Li₂MnO₃, sulfur, oxygen, or a combination thereof. In these formulas, M is Ti, V, Cr, Mn, Fe, Co, or Ni; Z is Ti, Zr, Nb, Al, or Mg; x is 0 to 1; y is 0 to 0.1; and z is −0.5 to 0.5. Preferably, the cathodic electro-active material is LiFePO₄, LiMnPO₄, LiVPO₄F, LiFeSO₄F, LiNi_{0.5}Mn_{0.5}O₂, LiCo_{1/3}Ni_{1/3}Mn_{1/3}O₂, LiMn₂O₄, LiNi_{0.5}Mn_{1.5}O₄, or a combination thereof. The p-type redox mediator can be a metallocene derivative, a triarylamine derivative, a phenothiazine derivative, a phenoxazine derivative, a carbazole derivative, a transition metal complex, an aromatic derivative, a nitroxide radical, a disulfide, or a combination thereof. Preferably, it is a metallocene derivative.

The anodic reservoir can contain an electrolyte, an anodic electro-active material and an n-type redox mediator. The anodic electro-active material can be a carbonaceous material, a lithium titanate (e.g., spinel Li₄Ti₅O₁₂), a metal oxide, a metal, a metal alloy, a metalloid, a metalloid alloy, a conjugated dicarboxylate, or a combination thereof. Preferably, it is Li₄Ti₅O₁₂, TiO₂, Si, Al, Sn, Sb, a carbonaceous material, or a combination thereof. When the anodic electro-active material contains a lithium metal (e.g., containing a lithium metal alone or with another material), the electrolyte is a solution in which one or more lithium salts are dissolved in an aprotic organic solvent. The n-type redox mediator can be a transition metal derivative, an aryl derivative, a conjugated carboxylate derivative, a rare earth metal cation, or a combination thereof. Preferably, it is a transition metal derivative, an aryl derivative, or a combination thereof.

The details of one or more embodiments of the invention are set forth in the description below. Other features, objects, and advantages of the invention will be apparent from the description and the claims.

### DETAILED DESCRIPTION

This disclosure provides a rechargeable electrochemical energy storage device, i.e., a redox flow battery system that can be configured for different applications, such as powering portable electronic devices and electrical vehicles, storing energy generated from remote power systems such as wind turbine generators and photovoltaic arrays, and providing emergency power as an uninterruptible power source.

In one embodiment, the redox flow battery system includes an energy reservoir and an electrochemical cell.

The electrochemical cell includes a cathodic compartment and an anodic compartment divided by a separator. The cathodic compartment contains a cathodic electrode and the anodic compartment contains an anodic electrode. Preferably, these two electrodes have high surface area, with or without one or more catalysts, to facilitate the charge collection process. They can be made of a carbon, a metal, or a combination thereof. Examples of an electrode can be found in Skyllas-Kazacos, et. al., Journal of The Electrochemical Society, 158, R55-79 (2011) and Weber, et. al., Journal of Applied Electrochemistry, 41, 1137-64 (2011).

The separator prevents cross-diffusion of the redox mediator and allows for movement of the electro-active ions (e.g., lithium ions, sodium ions, magnesium ions, aluminum ions, silver ions, copper ions, protons, or a combination thereof). For examples of a separator, see the Summary section above.

The energy reservoir contains an electrolyte, electro-active ions, an electro-active material, and a redox mediator.

An electrolyte is a solution in which electro-active ions are dissolved in a solvent such as a polar protic solvent, an aprotic solvent, and a combination thereof. The source of the electro-active ion can be a compound of the electro-active ion. For examples of a suitable compound, also see the Summary section above. The solvent can be water, a carbonate, an ether, an ester, a ketone, a nitrile, or a combination thereof. A carbonate solvent has the formula R₁OC(O)OR₂, in which each of R₁ and R₂, independently, can be alkyl or aryl. R₁ and R₂ together can also form a ring. Examples include, but are not limited to, propylene carbonate, 1,2-butylene carbonate, cis-2,3-butylene carbonate, trans-2,3-butylene carbonate, and diethyl carbonate. More carbonate solvents can be found in Schäffner et al., Chemical Reviews, 110 (8), 4554 (2010). An ether solvent, which can be a polyether solvent, has the formula R₁OR₂. Examples include, but are not limited to, dimethyl ether, dimethoxyethane, dioxane, tetrahydrofuran, anisole, crown ether, and polyethylene glycol. A ketone has the formula R₁C(O)R₂. It can be a diketone, an unsaturated ketone, and a cyclic ketone. Examples include, but are not limited to, acetone, acetylacetone, acetaphenone, methyl vinyl ketone, gamma-butyrolactone, and cyclohexanone.

An electro-active ion is an ion that is capable of being embedded (e.g., intercalated) in the electro-active material and moves from the anodic electrode to the cathodic electrode through the electrolyte and the separator during discharge of a rechargeable battery, and conversely during charging. Examples of an electro-active ion include, but are not limited to, a lithium ion, a sodium ion, a magnesium ion, an aluminum ion, a silver ion, a copper ion, a proton, a fluoride ion, a hydroxide ion, and a combination thereof. A lithium ion is preferred for the battery system.

An electro-active material is a material that can store and release an electro-active ion during charging and discharging in a battery. If the electro-active material has a high potential (e.g., losing electrons during charging), it is referred to as a “cathodic electro-active active material” herein. If the material has a low potential (e.g., acquiring electrons during charging), it is referred to as an “anodic electro-active material” herein. The electro-active material can be a solid, a liquid, a semi-solid, or a gel. Preferably, it is a solid that is stored and stays in the energy reservoir during charging/discharging.

A redox mediator refers to a compound present (e.g., dissolved) in the electrolyte that acts as a molecular shuttle transporting charges between the electrode and the electro-active material in the energy reservoir upon charging/discharging. The p-type redox mediator transports charges between the cathodic electrode and the cathodic electro-active material. The n-type redox mediator transports charges between the anodic electrode and the anodic electro-active material. Not being bound by any theory, upon charging, the p-type redox mediator is reduced on the surface of the cathodic electro-active material and is oxidized on the surface of the cathodic electrode, and the n-type redox mediator is oxidized on the surface of the anodic electro-active material and is reduced on the surface of the anodic electrode. Upon discharging, the reverse processes take place.

In another embodiment, the redox flow battery system includes an electrochemical cell and a cathodic energy reservoir.

The electrochemical cell includes a cathodic compartment and, an anodic compartment, and a separator.

The cathodic energy reservoir contains electro-active ions, cathodic electro-active materials, a p-type redox mediator, and an electrolyte. The electro-active ions and the electrolyte are described above, along with the electrochemical cell.

The cathodic electro-active material can be a metal fluoride (e.g., CuF₂, FeF₂, FeF₃, BiF₃, CoF₂, and NiF₂), a metal oxide (e.g., MnO₂, V₂O₅, V₆O_{I1}, Li₂O₂), Li_{1-x-z}M_{1-z}PO₄, (Li_{1-y}Z_{y})MPO₄, LiMO₂, LiM₂O₄, Li₂MSiO₄, a partially fluorinated compound (e.g., LiMPO₄F and LiMSO₄F, preferably, LiVPO₄F, LiFeSO₄F), Li₂MnO₃, sulfur, or oxygen. See the Summary section above for the definitions of M, Z, x, y, and z. Preferably, the cathodic electro-active material is a nanostructured material with a flat potential. The porosity, particle size, morphology, and microstructure of the solid cathodic electro-active material can be optimized to ensure an effective redox reaction with a p-type redox mediator in the electrolyte.

A p-type redox mediator, which circulates between the cathodic energy reservoir and the cathodic compartment, can be a metallocene derivative, a triarylamine derivative, a phenothiazine derivative, a phenoxazine derivative, a carbazole derivative, a transition metal complex, an aromatic derivative, a nitroxide radical, a disulfide, or a combination thereof. Preferably, it is a metallocene derivative.

The metallocene derivative can have the following structure:

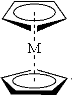

In the above formula, M can be Fe, Co, Ni, Cr, or V; each of the cyclopentadienyl rings, independently, can be substituted with one or more of the following groups: F, Cl, Br, I, NO₂, COOR, C₁₋₂₀ alkyl, CF₃, and COR, in which R can be H or C₁₋₂₀ alkyl.

The triarylamine derivative can have the following structure:

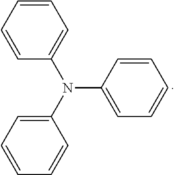 [SMILES: c1ccc(N(c2ccccc2)c2ccccc2)cc1]

In the above formula, each of the phenyl rings, independently, can be substituted with one is or more of the following groups: F, Cl, Br, I, NO₂, COOR, C₁₋₂₀ alkyl, CF₃, and COR, in which R can be H or C₁₋₂₀ alkyl.

The phenothiazine derivative and the phenoxazine derivative can have the following structure:

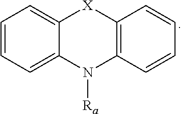

Rₐ can be H or C₁₋₂₀ alkyl, X can be O or S, each of the aromatic moieties is optionally substituted with one or more of the following groups: F, Cl, Br, I, NO₂, COOR, R, CF₃, and COR, in which R can be H or C₁₋₂₀ alkyl.

The carbazole derivative can have one of the following structures:

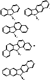

Rₓ can be H or C₁₋₂₀ alkyl and each of the aromatic moieties is optionally substituted with one or more of the following groups: F, Cl, Br, I, NO₂, COOR, C₁₋₂₀ alkyl, CF₃, and COR, in which R can be H or C₁₋₂₀ alkyl.

The transition metal complex can have one of the following structures:

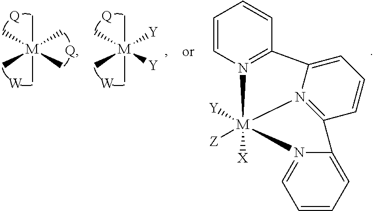

In the above formulas, M can Co, Ni, Fe, Mn, Ru, or Os; each of the aromatic moieties is optionally substituted with one or more of the following groups: F, Cl, Br, I, NO₂, COOR′, R′, CF₃, COR′, OR′, or NR′R″, each of R′ and R″, independently, being H or C₁₋₂₀ alkyl; each of X, Y, and Z, independently, can be F, Cl, Br, I, NO₂, CN, NCSe, NCS, or NCO; and each of Q and W, independently, can be

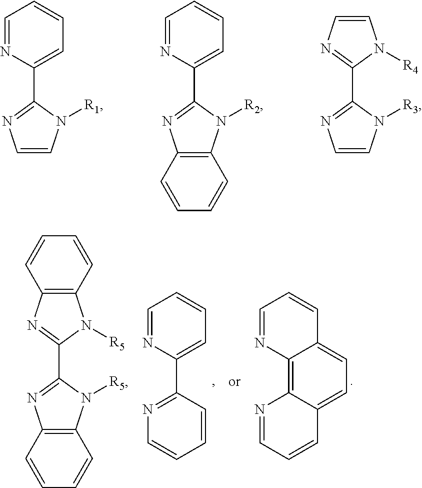

In these formulas, each of R₁, R₂, R₃, R₄, R₅, and R₆, can be F, Cl, Br, I, NO₂, COOR′, R′, CF₃, COR′, OR′, or NR′R″. Again, each of the aromatic moieties is optionally substituted with one or more of the following groups: F, Cl, Br, I, NO₂, COOR′, C₁₋₂₀ alkyl, CF₃, COR′, OR′, or NR′R″, in which each of R′ and R″, independently, can be H or C₁₋₂₀ alkyl.

The aromatic derivative can have the following structure:

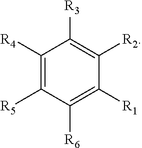

In these formulas, each of R₁, R₂, R₃, R₄, R₅, and R₆, can be C_{I}-₂₀ alkyl, F, Cl, Br, I, NO₂, COOR′, CF₃, COR′, OR′, OP(OR′)(OR″), or NR′R″, in which each of R′ and R″, independently, can be H, C₁₋₂₀ alkyl.

The nitroxide radical has the following structure:

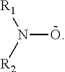

In these formulas, each of R₁ and R₂, independently, can be C₁₋₂₀ alkyl or aryl. R₁, R₂, and N together can form a heteroaryl, heteroaraalkyl, or heterocycloalkyl ring.

The disulfide has the following structure:

R₁—S—S—R₂.

In these formulas, each of R₁ and R₂, independently, can be C₁₋₂₀ alkyl, COOR′, CF₃, COR′, OR′, or NR′R″, in which each of R′ and R″, independently, can be H or C₁₋₂₀ alkyl.

In still another embodiment, the redox flow battery system includes an anodic energy reservoir and an electrochemical cell.

The electrochemical cell includes an anodic compartment and a cathodic compartment divided by a separator.

The anodic energy reservoir contains electro-active ions, anodic electro-active materials, an n-type redox mediator, and an electrolyte. The electro-active ions and the electrolyte are described above, along with the electrochemical cell.

The anodic electro-active material can be a carbonaceous material (e.g., a graphite, a hard carbon, a disordered carbon, a doped graphitic carbon alloy with N, S, or B, and a disordered carbon alloy with N, S, or B); a lithium titanate (e.g., spinel Li₄Ti₅O₁₂); a metal oxide (e.g., TiO₂, SnO, SnO₂, Sb₂O₅, Fe₂O₃, CoO, Co₃O₄, NiO, CuO, and MnOₓ, preferably a nanocrystalline metal oxide); a metal, a metal alloy, a metalloid, a metalloid alloy (e.g., Sn, Ga, In, Sn, Pb, Bi, Zn, Ag, Al, Si, Ge, B, As, Sb, Te, Se, and a combination thereof); a conjugated dicarboxylate; and a lithium metal. A conjugated dicarboxylate is an organic compound that has two or more carboxylate groups conjugated within its molecular, capable of binding with electro-active ions. Examples of a conjugated dicarboxylate include, but are not limited to, Li terephthalate (Li₂C₈H₄O₄) and Li trans-trans-muconate (Li₂C₆H₄O₄). More examples of a conjugated dicarboxylate can be found in Armand et. al., Nature Materials, 8, 120 (2009). Preferably, the anodic electro-active material is a nanostructured material with a flat potential. The porosity, the particle size, the morphology, and the microstructure of the negative electrode material can be optimized to ensure an effective redox reaction with an n-type redox mediator in the electrolyte.

An n-type redox mediator, which is present in the electrolyte and circulates between the anodic energy reservoir and the anodic compartment, can be a transition metal derivative, an aryl derivative, a conjugated carboxylate derivative, a rare earth metal cation, or a combination thereof.

The transition metal derivative can have the following structure:

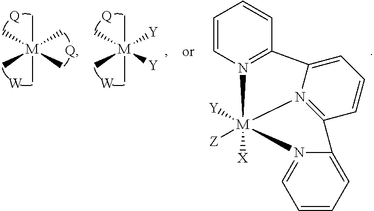

In the above formulas, M can Fe, Ru, or Os; each of the aromatic moieties is optionally substituted with one or more of the following groups: F, Cl, Br, I, NO₂, COOR′, R′, CF₃, COR′, OR′, or NR′R″, each of R′ and R″, independently, being H or C₁₋₂₀ alkyl; each of X, Y, and Z, independently, can be F, Cl, Br, I, NO₂, CN, NCSe, NCS, or NCO; and each of Q and W, independently, can be

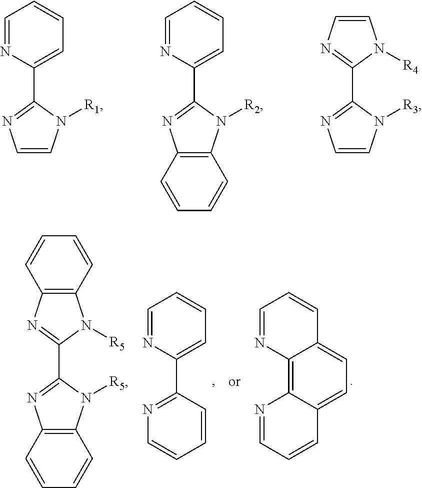

In these formulas, each of R₁, R₂, R₃, R₄, R₅, and R₆, can be F, Cl, Br, I, NO₂, COOR′, R′, CF₃, COR′, OR′, or NR′R″. Again, each of the aromatic moieties is optionally substituted with one or more of the following groups: F, Cl, Br, I, NO₂, COOR′, C₁₋₂₀ alkyl, CF₃, COR′, OR′, or NR′R″, in which each of R′ and R″, independently, can be H or C₁₋₂₀ alkyl.

The aryl derivative can have the following structure:

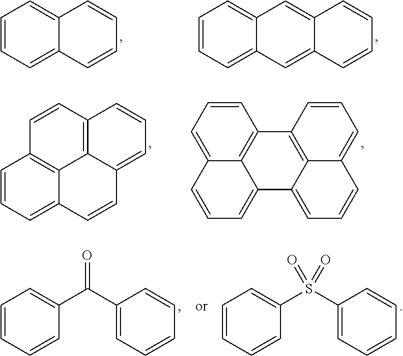

is In the above formula, the phenyl ring can be substituted with one or more of the following groups: F, Cl, Br, I, NO₂, C₁₋₂₀ alkyl, CF₃, COOR′, OR′, COR′, or NR′R″, in which each of R′ and R″, independently, can be H or C₁₋₂₀ alkyl.

The conjugated carboxylate derivative can have the following structure:

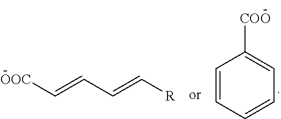

In the above formula, R can be F, Cl, Br, I, NO₂, C₁₋₂₀ alkyl, CF₃, COOR′, OR′, COR′, or NR′R″; the phenyl ring can be substituted with one or more of the following groups: F, Cl, Br, I, NO₂, C₁₋₂₀ alkyl, CF₃, COOR′, OR′, COR′, or NR′R″, in which each of R′ and R″, independently, can be H or C₁₋₂₀ alkyl. Note that the conjugated carboxylate derivative described above is in an anion form, which can be present in the electrolyte. This derivative can also be in an acid form or a salt form.

A rare earth metal is one of the fifteen lanthanides in the periodic table, scandium, and yttrium. A rare earth metal cation is a positively charged ion of the rare earth metal atom.

International Patent Application Publication WO 2007/116363 provides many examples of a p-type redox mediator (also known as a p-type redox active compound, a p-type redox molecule, or a p-type shuttle molecule) and further provides many examples of an n-type redox mediator (also known as, an n-type redox active compound, an n-type redox molecule, or an n-type shuttle molecule).

In yet another embodiment, the redox flow battery system includes a cathodic energy reservoir, an anodic energy reservoir, and an electrochemical cell.

Still within the scope of this invention is a redox flow battery system that includes a cathodic energy reservoir, an anodic energy reservoir, and a plurality of electrochemical cells.

Optionally, the battery system of this invention has a control element such as a pump for driving the flow of the electrolyte between the energy reservoir and the electrochemical cell. The rate and direction of the flow on either electrode can be controlled by adjusting the speed of the pump.

The battery system of this invention has a higher energy density than those of traditional redox flow batteries. Compared to lithium ion batteries, this system does not require a bulky conducting additive and a voluminous binder, saving room for more electro-active materials and thus further increasing its energy density. In addition, the battery system can be rapidly refueled by replacing its energy reservoir with a charged one (in a similar way to refilling a fuel tank for an internal combustion engine). The energy reservoir is then recharged externally. The energy reservoir contains the bulk of the electro-active materials of the battery system. During the operation, there is only a small amount of the redox mediator flowing into the electrochemical cell. The safety of the cell is thus greatly improved.

The term “alkyl” herein refers to a straight or branched hydrocarbon group, containing 1-20 carbon atoms. Examples of an alkyl group include, but are not limited to, methyl, ethyl, n-propyl, i-propyl, n-butyl, i-butyl, and t-butyl. The term “aryl” (i.e., “aromatic”) refers to a 6-carbon monocyclic, 10-carbon bicyclic, 14-carbon tricyclic aromatic ring system wherein each ring can have 1 to 4 substituents. Examples of an aryl group include, but are not limited to, phenyl, naphthyl, and anthracenyl.

The term “heteroaryl” refers to an aromatic 5-8 membered monocyclic, 8-12 membered bicyclic, or 11-14 membered tricyclic ring system having one or more heteroatoms (such as N). Examples of heteroaryl groups include pyridyl, imidazolyl, benzimidazolyl, pyrimidinyl, quinolinyl, and indolyl. The term “heteroaralkyl” refers to an alkyl group substituted with a heteroaryl group.

The term “heterocycloalkyl” refers to a nonaromatic 5-8 membered monocyclic, 8-12 membered bicyclic, or 11-14 membered tricyclic ring system having one or more heteroatoms (such as N). Examples of heterocycloalkyl groups include, but are not limited to, piperazinyl, pyrrolidinyl, and morpholinyl.

Without further elaboration, it is believed that one skilled in the art can, based on the description herein, utilize the present invention to its fullest extent. All publications cited herein are incorporated by reference in their entirety.

### EXAMPLES

A redox flow lithium half-cell battery was assembled. In this battery, graphite plate was used as the cathodic electrode, ferrocene (50 mmol/L) as the p-type redox mediator, LiFePO₄ powder as the cathodic electro-active material, lithium foil as the anodic electrode, LISCON glass ceramic membrane (150 μm) as the separator, LiPF₆ (1000 mmol/L) as the electrolyte, and DMC:EC (1:1, v/v) as the solvent.

A similar half-cell battery was also assembled. It is identical to the one just described except that 1,1′-dibromoferrocene (50 mmol/L) was used as the p-type redox mediator.

The reservoir was connected to the cathodic compartment via an outlet for delivering the electrolyte from the energy reservoir to the cathodic compartment and also via an inlet for returning the electrolyte from the cathodic compartment to the reservoir. The electrolyte was circulated by a peristaltic pump.

The two batteries were tested at a constant current density of 0.2 mA/cm² and threshold voltages of 2.60 and 4.20 V vs. Li⁺/Li, respectively. Unexpectedly, for both batteries, more than 70% of the LiFePO₄ stored in the reservoir was reacted in the charge/discharge process.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A redox flow battery system having an electrochemical cell, the system comprising:
a cathodic compartment having a cathodic electrode;
an anodic compartment having an anodic electrode;
an energy reservoir (i) containing an electro-active material that stores electro-active ions, an electrolyte that contains the electro-active ions, and a redox mediator that is present in the electrolyte, and (ii) connected to either the cathodic compartment or the anodic compartment via an outlet for delivering the electrolyte from the energy reservoir to the cathodic compartment or the anodic compartment, and also via an inlet for returning the electrolyte from the cathodic compartment or the anodic compartment to the reservoir; and
a separator that divides the cathodic compartment and the anodic compartment while allowing the electro-active ions to move therebetween.

2. The battery system of claim 1, wherein the electro-active ions are lithium ions, sodium ions, magnesium ions, aluminum ions, silver ions, copper ions, protons, fluoride ions, hydroxide ions, or a combination thereof.

3. The battery system of claim 2, wherein the energy reservoir is connected to the cathodic compartment, the electro-active material therein being a cathodic electro-active material and the redox mediator therein being a p-type redox mediator.

4. The battery system of claim 2, wherein the energy reservoir is connected to the anodic compartment, the electro-active material therein being an anodic electro-active material and the redox mediator therein being an n-type redox mediator.

5. The battery system of claim 2, wherein the electro-active ions are lithium ions.

6. The battery system of claim 5, wherein the energy reservoir is connected to the cathodic compartment, the electro-active material therein being a cathodic electro-active material and the redox mediator therein being a p-type redox mediator.

7. The battery system of claim 6, wherein
the cathodic electro-active material is a metal fluoride, a metal oxide, Li_{1-x-z}M_{1-z}PO₄, (Li_{1-y}Z_{y})MPO₄, LiMO₂, LiM₂O₄, Li₂MSiO₄, LiMPO₄F, LiMSO₄F, Li₂MnO₃, sulfur, oxygen, or a combination thereof, in which M is Ti, V, Cr, Mn, Fe, Co, or Ni, Z is Ti, Zr, Nb, Al, or Mg, x is 0 to 1, y is 0 to 0.1, and z is −0.5 to 0.5;
the electrolyte is a solution in which one or more lithium salts are dissolved in a polar protic solvent, an aprotic solvent, or a combination thereof;
the p-type redox mediator is a metallocene derivative, a triarylamine derivative, a phenothiazine derivative, a phenoxazine derivative, a carbazole derivative, a transition metal complex, an aromatic derivative, a nitroxide radical, a disulfide, or a combination is thereof; and
the separator is a lithium ion conducting membrane.

8. The battery system of claim 7, wherein
the cathodic electro-active material is LiFePO₄, LiMnPO₄, LiVPO₄F, LiFeSO₄F, LiNi_{0.5}Mn_{0.5}O₂, LiCo_{1/3}Ni_{1/3}Mn_{1/3}O₂, LiMn₂O₄, LiNi_{0.5}Mn_{1.5}O₄, or a combination thereof;
the electrolyte is a solution in which LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAIO₄, LiAlCl₄, LiCl, LiI, lithium bis(oxalato)borate, or a combination thereof is dissolved in water, a carbonate, an ether, an ester, a ketone, a nitrile, or a combination thereof;
the p-type redox mediator is a metallocene derivative; and
the separator is a lithium phosphorus oxynitride glass, a lithium thiophosphate glass, a NASICON-type lithium conducting glass ceramic, a Garnet-type lithium conducting glass ceramic, a ceramic nanofiltration membrane, a lithium ion-exchange membrane, or a combination thereof.

9. The battery system of claim 5, wherein the energy reservoir is connected to the anodic compartment, the electro-active material therein being an anodic electro-active material and the redox mediator therein being an n-type redox mediator.

10. The battery system of claim 9, wherein
the anodic electro-active material is a carbonaceous material, a lithium titanate, a metal oxide, a metal, a metal alloy, a metalloid, a metalloid alloy, a conjugated dicarboxylate, or a combination thereof;
the electrolyte is a solution in which one or more lithium salts are dissolved in a io polar protic solvent, an aprotic solvent, or a combination thereof;
the n-type redox mediator is a transition metal derivative, an aryl derivative, a conjugated carboxylate derivative, a rare earth metal cation, or a combination thereof; and
the separator is a lithium ion conducting membrane, provided that when the anodic electro-active material contains a lithium metal, the electrolyte is a solution in which one or more lithium salts are dissolved in an aprotic organic solvent.

11. The battery system of claim 10, wherein
the anodic electro-active material is Li₄Ti₅O₁₂, TiO₂, Si, Al, Sn, Sb, a carbonaceous material, or a combination thereof;
the electrolyte is a solution in which LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAlO₄, LiAlCl₄, LiCI, LiI, lithium bis(oxalato)borate, or a combination thereof is dissolved in water, a carbonate, an ether, an ester, a ketone, a nitrile, or a combination thereof;
the n-type redox mediator is a transition metal derivative, an aryl derivative, or a combination thereof; and
the separator is a lithium phosphorus oxynitride glass, a lithium thiophosphate glass, a NASICON-type lithium conducting glass ceramic, a Garnet-type lithium conducting glass ceramic, a ceramic nanofiltration membrane, a lithium ion-exchange membrane, or a combination thereof.

12. The battery system of claim 1, wherein the cathodic electrode, is a carbon, a metal, or a combination thereof; and the anodic electrode is a carbon, a metal, or a combination thereof.

13. The battery system of claim 12, wherein
the energy reservoir is connected to the cathodic compartment;
the electro-active material therein is a metal fluoride, a metal oxide, Li_{1-x-z}M_{1-z}PO₄, (Li_{1-y}Z_{y})MPO₄, LiMO₂, LiM₂O₄, Li₂MSiO₄, LiMPO₄F, LiMSO₄F, Li₂MnO₃, sulfur, oxygen, or a combination thereof; in which M is Ti, V, Cr, Mn, Fe, Co, or Ni, Z is Ti, Zr, Nb, Al, or Mg, x is 0 to 1, y is 0 to 0.1, and z is −0.5 to 0.5;
the electrolyte is a solution in which one or more lithium salts are dissolved in a polar protic solvent, an aprotic solvent, or a combination thereof; and
the redox mediator therein is a p-type redox mediator.

14. The battery system of claim 12, wherein
the energy reservoir is connected to the anodic compartment;
the electro-active material therein is a carbonaceous material, a lithium titanate, a metal oxide, a conjugated dicarboxylate, a metal, a metal alloy, a metalloid, a metalloid alloy, a lithium metal, or a combination thereof;
the electrolyte is a solution in which one or more lithium salts dissolved in a polar protic solvent, an aprotic solvent, or a combination thereof; and
the redox mediator therein is an n-type redox mediator, provided that when the anodic electro-active material contains a lithium metal, the electrolyte is a solution in which one or more lithium salts are dissolved in an aprotic organic solvent.

15. The battery system of claim 1, further comprising a second energy reservoir, wherein
one of the two energy reservoirs is connected to the cathodic compartment, in which the electro-active material is a cathodic electro-active material and the redox mediator is a p-type redox mediator; and
the other energy reservoir is connected to the anodic compartment, in which the electro-active material is an anodic electro-active material and the redox mediator is an n-type redox mediator.

16. The battery system of claim 15, wherein the electro-active ions are lithium ions, sodium ions, magnesium ions, aluminum ions, silver ions, copper ions, protons, fluoride ions, hydroxide ions, or a combination thereof.

17. The battery system of claim 16, wherein the electro-active ions are lithium ions.

18. The battery system of claim 17, wherein
the cathodic electro-active material is a metal fluoride, a metal oxide, Li_{1-x-z}M_{1-z}PO₄, (Li_{1-y}Z_{y})MPO₄, LiMO₂, LiM₂O₄, Li₂MSiO₄, LiMPO₄F, LiMSO₄F, Li₂MnO₃, sulfur, oxygen, or a combination thereof, in which M is Ti, V, Cr, Mn, Fe, Co, or Ni, Z is Ti, Zr, Nb, Al, or Mg, x is 0 to 1, y is 0 to 0.1, and z is −0.5 to 0.5;
the anodic electro-active material is a carbonaceous material, a lithium titanate, a metal oxide, a conjugated dicarboxylate, a metal, a metal alloy, a metalloid, a metalloid alloy, or a combination thereof;
the electrolyte is a solution in which one or more lithium salts are dissolved in a polar protic solvent, an aprotic solvent, or a combination thereof;
the p-type redox mediator is a metallocene derivative, a triarylamine derivative, a phenothiazine derivative, a phenoxazine derivative, a carbazole derivative, a transition metal complex, an aromatic derivative, a nitroxide radical, a disulfide, or a combination thereof;
the n-type redox mediator is a transition metal derivative, an aryl derivative, a conjugated carboxylate derivative, a rare earth metal cation, or a combination thereof; and
the separator is a lithium ion conducting membrane, provided that when the anodic electro-active material contains a lithium metal, the electrolyte is a solution in which one or more lithium salts are dissolved in an aprotic organic solvent.

19. The battery system of claim 18, wherein
the cathodic electro-active material is LiFePO₄, LiMnPO₄, LiVPO₄F, LiFeSO₄F, LiNi_{0.5}Mn_{0.5}O₂, LiCo_{1/3}Ni _{1/3}M1/3O₂, LiMn₂O₄, LiNi_{0.5}Mn_{1.5}O₄, or a combination thereof;
the anodic electro-active material is Li₄Ti₅O₁₂, TiO₂, Si, Al, Sn, Sb, a carbonaceous material, or a combination thereof;
the electrolyte is a solution in which LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAlO₄, LiAlCL₄, LiCl, LiI, lithium bis(oxalato)borate, or a combination thereof is dissolved in water, a carbonate, an ether, an ester, a ketone, a nitrile, or a combination thereof;
the p-type redox mediator is a metallocene derivative;
the n-type redox mediator is a transition metal derivative, an aryl derivative, or a combination thereof; and
the separator is a lithium phosphorus oxynitride glass, a lithium thiophosphate glass, a NASICON-type lithium conducting glass ceramic, a Garnet-type lithium conducting glass ceramic, a ceramic nanofiltration membrane, a lithium ion-exchange membrane, or a combination thereof.

20. The battery system of claim 17, wherein the cathodic electrode is a carbon, a metal, or a combination thereof; and the anodic electrode is a carbon, a metal, or a combination thereof.

21. The battery system of claim 20, wherein
the cathodic electro-active material is a metal fluoride, a metal oxide, Li_{1-x-z}M_{1-z}PO₄, (Li_{1-y}Z_{y})MPO₄, LiMO₂, LiM₂O₄, Li₂MSiO₄, LiMPO₄F, LiMSO₄F, Li₂MnO₃, sulfur, oxygen, or a combination thereof, in which M is Ti, V, Cr, Mn, Fe, Co, or Ni, Z is Ti, Zr, Nb, Al, or Mg, x is 0 to 1,y is 0 to 0.1, and z is −0.5 to 0.5;
the anodic electro-active material is a carbonaceous material, a lithium titanate, a metal oxide, a conjugated dicarboxylate, a metal, a metal alloy, a metalloid, a metalloid alloy, or a combination thereof;
the electrolyte is a solution in which one or more lithium salts are dissolved in a polar protic solvent, an aprotic solvent, or a combination thereof;
the p-type redox mediator is a metallocene derivative, a triarylamine derivative, a phenothiazine derivative, a phenoxazine derivative, a carbazole derivative, a transition metal complex, an aromatic derivative, a nitroxide radical, a disulfide, or a combination thereof;
the n-type redox mediator is a transition metal derivative, an aryl derivative, a conjugated carboxylate derivative, a rare earth metal cation, or a combination thereof; and
the separator is a lithium ion conducting membrane, provided that when the anodic electro-active material contains a lithium metal, the electrolyte is a solution in which one or more lithium salts are dissolved in an aprotic o organic solvent.

22. The battery system of claim 21, wherein
the cathodic electro-active material is LiFePO₄, LiMnPO₄, LiVPO₄F, LiFeSO₄F, LiNi_{0.5}Mn_{0.5}O₂, LiCo_{1/3}Ni_{1/3}Mn_{1/3}O₂, LiMn₂O₄, LiNi_{0.5}Mn_{1.5}O₄, or a combination thereof;
the anodic electro-active material is Li₄Ti₅O₁₂, TiO₂, Si, Al, Sn, Sb, a carbonaceous material, or a combination thereof;
the electrolyte is a solution in which LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAlO₄, LiAlCl₄, LiCI, LiI, lithium bis(oxalato)borate, or a combination thereof is dissolved in water, a carbonate, an ether, an ester, a ketone, a nitrile, or a combination thereof;
the p-type redox mediator is a metallocene derivative;
the n-type redox mediator is a transition metal derivative, an aryl derivative, or a combination thereof; and
the separator is a lithium phosphorus oxynitride glass, a lithium thiophosphate glass, a NASICON-type lithium conducting glass ceramic, a Garnet-type lithium conducting glass ceramic, a ceramic nanofiltration membrane, a lithium ion-exchange membrane, or a combination thereof.

23. The battery system of claim 1, wherein the battery system has a plurality of electrochemical cells, the cathodic electrode is connected to one or more other cells or to an external load, and the anodic electrode is connected to one or more other cells or to an external load.
